(19) United States
(12) Patent Application Publication
(10) Pub. No.: US 2007/0252806 A1
(43) Pub. Date: Nov. 1, 2007

(54) DRIVE STRUCTURE FOR A SEQUENTIAL RGB DISPLAY

(76) Inventors: Jin-Wook KWON, Suwon-si (KR); Mun-Kue PARK, Suwon-si (KR); Yong-Chan KEH, Seoul (KR)

Correspondence Address: CHA & REITER, LLC, 210 ROUTE 4 EAST STE 103, PARAMUS, NJ, 07652, US

(21) Appl. No.: 11/627,443

(22) Filed: Jan. 26, 2007

(30) Foreign Application Priority Data
Apr. 26, 2006 (KR) 37691/2006

(51) Int. Cl. G09G 3/36

(52) U.S. Cl. 345/102

(57) ABSTRACT

A drive structure is provided for a sequential Red-Green-Blue (RGB) display. One light receiving means receives part of light output from R, G, and B light sources and performs conversion to a current signal. Each light source driver performs a control operation for maintaining the light intensity of each light source substantially constant by adjusting an amount of operating current applied thereto according to the magnitude of a feedback current provided from the light receiving means. Light is sequentially emitted by the light sources and received by the light monitoring device in response to input R, G, and B modulation signals.

### CLAIM OF PRIORITY

This application claims the benefit of the earlier filing date, pursuant to 35 U.S.C. § 119, to that patent application entitled “Drive Structure for a Sequential RGB Display,” filed in the Korean Intellectual Property Office on Apr. 26, 2006 and assigned Serial No. 2006-37691, the contents of which are incorporated herein by reference.

### BACKGROUND OF THE INVENTION

1. Field of the Invention

The present invention relates to a drive structure for a sequential Red-Green-Blue (RGB) display, and more particularly to a display drive structure for performing a control operation for maintaining substantially constant the light intensity of each light source.

2. Description of the Related Art

A conventional semiconductor laser diode (LD) has a mold structure. In this structure, an LD chip emits a majority the laser light (80 to 90%) in a front direction, and emits the remaining laser light in a rear direction. A photodiode (PD) is mounted in the rear direction of the LD chip to detect the laser light emitted in the rear direction of the LD chip. A package of optical devices such as the LD and the PD typically uses an optical module of a TO-CAN structure.

The optical module of the conventional TO-CAN structure is provided with multiple leads on one surface. For example, a multi-lead structure is provided with a radio frequency (RF) lead and a direct current (DC) bias lead connected to a cathode of an LD, an anode lead connected to an anode of a monitoring photodiode (MPD), and a common lead connected to an anode of the LD and a cathode of the MPD. The LD and PD are connected to the leads by wire bonding and so on.

An optical module array is a light source array in which LDs and PDs are arranged in two dimensions. In the optical module array, three Red-Green-Blue (RGB) LDs are installed which are mapped to multiple pixels. Alternatively, one pixel may be mapped to three RGB LDs.

Multiple RGB PDs are provided to detect light output from LDs. For pixels, at least one light emitting device arranged in a light source array is referred to as a light source unit. For example, at least one red, green or blue LD may be referred to as a light source unit.

Alternatively, three RGB LDs, one row or column, or a rectangular area (e.g., 2*2, 4*4, or 2*4) of the light source array may be considered as a light source unit. For a better understanding, it is assumed that the optical module is three LDs and PDs for detecting light from respective LDs. As long as the light source is not specially limited, it indicates a conventional lamp light source, light source array or light emitting diode.

Conventional image display devices for displaying large images are well known. These projection devices are provided with a projection tube serving as a light source for projecting a light beam on a display screen. When images are displayed on the display screen, viewers can view the images displayed on the display screen. Up to now, a high-brightness projection tube has been used for the light source of the image display device. Conventionally, the images are displayed on the display screen serving as a liquid crystal panel through light beams projected from the projection tube.

FIG. 1 is a schematic diagram illustrating a structure of a conventional image display device.

The conventional image display device 100 of FIG. 1 uses a semiconductor light source driver. The conventional image display device 100 of FIG. 1 can perform a high-brightness display operation by self-emission when RGB signals (e.g., video signals or television image signals) are input. Thus, the image display device 100 is suitable for a small-sized display screen. In FIG. 1, the references RED, GREEN, and BLUE represent a red signal, a green signal, and a blue signal, respectively.

Each semiconductor light source driver drives a respective light source unit of the image display device 100.

Semiconductor light source drivers control the three RGB LDs 140, 150, and 160 for outputting laser light and three PDs 170 for receiving part of the light or monitoring light output from the LDs 140, 150, and 160. Further, the semiconductor light source drivers control light outputs of the LDs 140, 150, and 160 by adjusting feedback currents of the PDs 170. Herein, the semiconductor light source drivers serving as three RGB LD drivers 110, 120, and 130 periodically check optical power states of the light sources s from the LDs 140, 150, and 160 for emitting laser light to a desired optical system in a predetermined direction. The semiconductor light source drivers obtain necessary information from part of the beams detected by the PDs. When needed, a variable resistor R_{bias} capable of variably adjusting the light intensity may be attached. Thus, the light intensity can be controlled by adjusting the amount of operating current of an associated LD 140, 150, or 160.

When the image display device 100 performs voltage driving as in a liquid crystal display (LCD), the LDs 140, 150, and 160 emit light for RGB image signals input via resistors from an external image processor (not illustrated). A feedback current mapped to the emitted light is provided. In one proposed semiconductor light source driver of the image display device 100 the number of terminal pins is 396 (=132×3) and the number of row terminal pins is 162. In the case of a full color display, it is a trend that the number of PDs 170 and the number of terminal pins of the LDs 140, 150, and 160 are continuously increasing. Thus, there is a problem in that price and size of a product increase and a configuration becomes every increasingly complex as the number of PDs 170 and the number of terminal pins increases.

### SUMMARY OF THE INVENTION

The present invention maintains the brightness of a light source display substantially constant by performing a control operation for maintaining the light intensity of each light source even in a variation in an ambient temperature or operating temperature, by enabling a light source driver to adjust an amount of operating current to be applied to a corresponding light source according to the magnitude of a feedback current provided from a light receiving means.

In accordance with an aspect of the present invention, there is provided a light source display device, comprising: at least one light source for outputting light, one light receiving means for receiving part of the light output from the at least one light source and performing conversion to a current signal and at least one light source driver for performing a control operation for maintaining a light intensity of the at least one light source substantially constant by adjusting an operating current in response to a feedback current provided from the light receiving means.

### BRIEF DESCRIPTION OF THE DRAWINGS

The above features and advantages of the present invention will be more clearly understood from the following detailed description taken in conjunction with the accompanying drawings, in which:

FIG. 1 is a schematic diagram illustrating a structure of a conventional image display device;

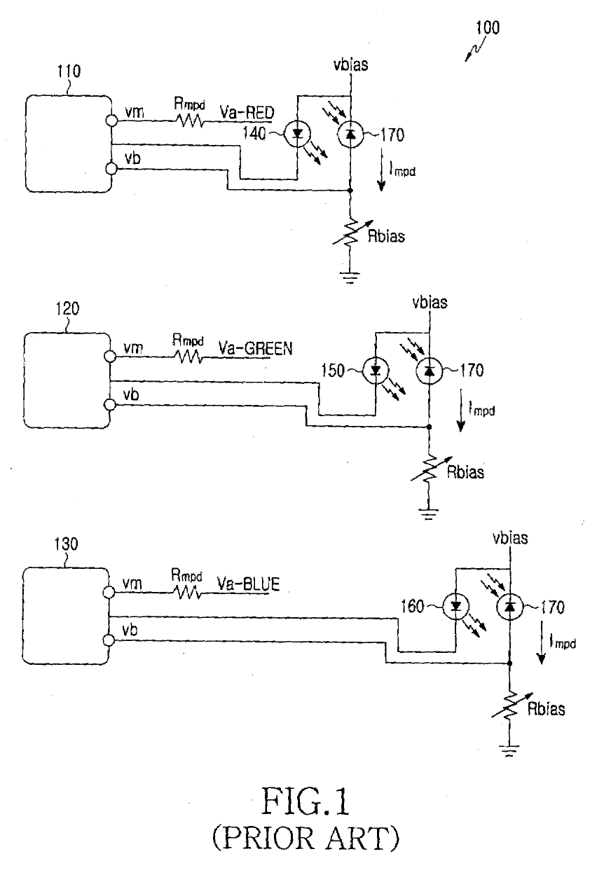

FIG. 2 is a schematic diagram illustrating a drive structure for a sequential Red-Green-Blue (RGB) display in accordance with an exemplary embodiment of the present invention;

FIG. 3 is a circuit diagram illustrating a red laser diode driver in the drive structure for a sequential RGB display in accordance with an exemplary embodiment of the present invention; and

FIG. 4 illustrates a structure of fields within a frame of the drive structure for a sequential RGB display in accordance with an exemplary embodiment of the present invention.

### DETAILED DESCRIPTION OF THE EXEMPLARY EMBODIMENTS

Exemplary embodiments of the present invention will be described in detail herein below with reference to the accompanying drawings.

Display devices using light sources of red, green and blue have been proposed due to easy modulation of image signals, color reproduction improvement, and brightness improvement. In particular, when a semiconductor laser is used for a display light source, the light intensity is varied due to a variation in an ambient temperature or operating temperature, such that color quality of a display device may be deteriorated. Thus, a device for maintaining the light intensity of a light source substantially constant is required.

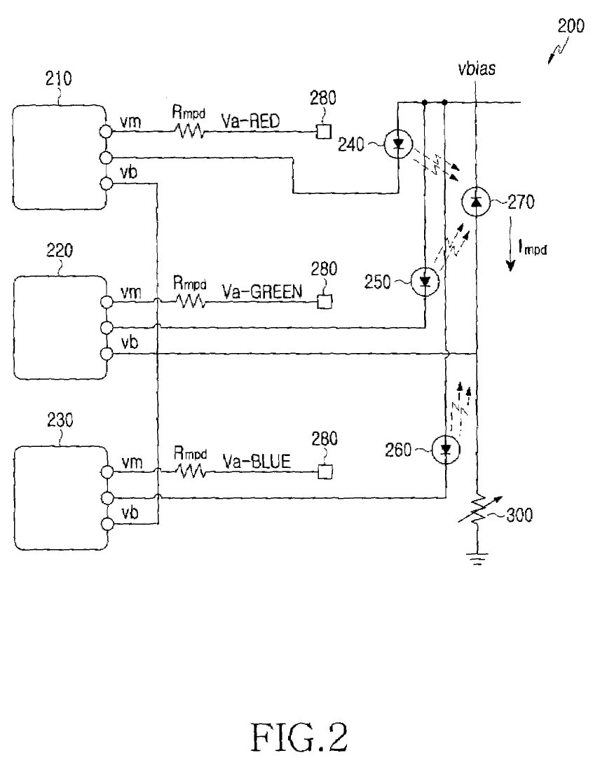

FIG. 2 is a schematic diagram illustrating a drive structure for a sequential Red-Green-Blue (RGB) display in accordance with an exemplary embodiment of the present invention.

As illustrated in FIG. 2, the drive structure 200 for a sequential RGB display in accordance with the exemplary embodiment of the present invention is provided with RGB light sources 240, 250, 260 for outputting light of a known color or wavelength or range of wavelengths, one light receiving means for receiving part of the light from each light source and performing conversion to a current signal, and RGB light source drivers for performing control operations for constantly maintaining the light intensities of the light sources according to operating currents received from the light receiving means and external RGB modulation signals.

In the drive structure 200 for a sequential RGB display in accordance with the exemplary embodiment of the present invention, a light source outputs light in the front and rear directions. In a TO-CAN structure in which multiple light source units are arranged, RGB laser diodes (LDs) 240, 250, and 260 form a light source array. Further, the LDs 240, 250, and 260 emit laser light in proportion to the magnitude of an applied operating current, respectively.

The light receiving means is configured with one monitor photodiode (MPD) 270 for detecting part of light output from the RGB LDs 240, 250, and 260

The LDs 240, 250, and 260 are driven by forward bias, whereas the MPD 270 is driven by reverse bias. LD drivers 210, 220, 230 are connected to cathodes of the LDs 240, 250, and 260, respectively, and an anode of the MPD 270, and are commonly connected to a resistor circuit 300. In this structure, a feedback current detected from the MPD 270 is provided to a light source driver.

The light source driver is provided with the LD drivers 210, 220, and 230 for controlling operating currents for sequentially emitting light from the RGB LDs 240, 250, and 260 in response to RGB modulation signals input via input terminals 280 from an external image processor (not illustrated).

The LD drivers 210, 220, and 230 are different from one another in that types of light sources for outputting light in response to the input RGB modulation signals are different. Further, operating currents of the LDs differ according to the magnitudes of resistors R_{mod}.

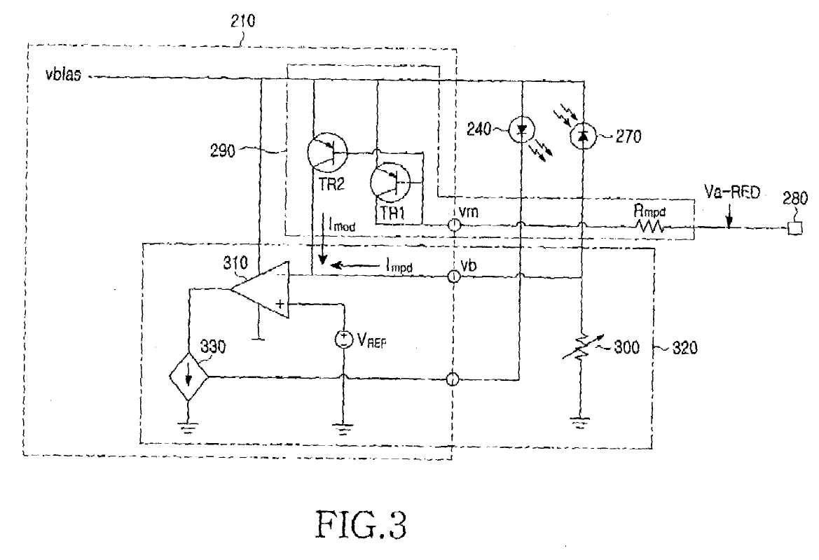

FIG. 3 is a circuit diagram illustrating a red LD driver in the drive structure for a sequential RGB display in accordance with an exemplary embodiment of the present invention.

For example, a red LD driver 210 will be described below. As illustrated in FIG. 3, the red LD driver 210 in accordance with the exemplary embodiment of the present invention includes a current mirror 290 for outputting a constant current. The current mirror 290 includes a resistor R_{mpd} for dropping a voltage according to a red modulation signal of an input terminal 280. In the current mirror 290, the resistor R_{mpd} is connected to the input terminal 280 for receiving the red modulation signal. The current mirror 290 is configured with PNP input and output transistors TR1 and TR2 in which a common base is connected to the resistor R_{mpd} and a collector. A bias voltage v_{bias} is supplied to emitters of the transistors TR1 and TR2.

Further, the red LD driver 210 includes a resistor circuit 300 for dropping a voltage according to a feedback current I_{mpd} output from an MPD 270 for receiving part of light output from a red LD 240 and performing conversion to a current signal. In the red LD driver 210, an automatic power controller 320 includes a comparator 310 for comparing a preset reference voltage V_{REF} with a voltage v_{b} generated by an electric current flowing to the resistor circuit 300 when a constant current I_{mod} output from the current mirror 290 is added to the current output I_{mpd} from the MPD 270. On the other hand, the automatic power controller 320 further includes a current source 330 for adjusting an amount of current to be supplied to the red LD 240 in response to a signal output from the comparator 310.

Herein, the resistor circuit 300 is provided with a load resistor for protecting the red LD 240 from static electricity or a variable resistor R_{bias} for adjusting light power of the red LD 240 in response to the feedback current I_{mpd} output from the MPD 270.

The automatic power controller 320 performs a control operation for maintaining laser light power of the red LD 240 substantially constant by varying the operating current to be applied to the red LD 240 according to the magnitude of the feedback current provided from the MPD as in an automatic power control (APC) scheme. Further, the feedback current I_{mpd} is obtained by converting light detected by the MPD 270 to an electric current with respect to laser light output from the red LD 240.

In particular, the resistor circuit 300 includes a variable resistor R_{bias} for variably adjusting light power, such that an initial light-quantity state of the LD can be adjusted when a laser display device is manufactured. As a result, when an amount of feedback current to be output from one MPD 270 is adjusted through the variable resistor R_{bias}, an amount of current flowing to the LD is varied and therefore an amount of operating current is varied in the drive structure 200 for a sequential RGB display.

Direct current (DC) characteristics of the LD determine the output current I_{mpd} of the MPD 270 for receiving part of light output from the red LD 240 and performing conversion to a current signal, i.e., the feedback current. In other words, an operating current of the laser for obtaining the desired light intensity is defined by the DC characteristics of the LD. When the operating current flows to the laser, the output current I_{mpd} of the MPD 270 is defined. When the feedback current I_{mpd} is output from the MPD 270, a voltage drop is caused by the resistor circuit 300 and the comparator 310 compares the associated voltage with the preset reference voltage V_{REF}. The resistance value is defined as shown in Equation (1), and is input to the automatic power controller 320 for adjusting the light intensity of the red LD 240.

R_{bias}=V_{REF}/I_{mpd}(or a given value in a laser DC characteristic curve) [1]

When a red modulation signal (of an amplitude voltage Va) is input to the input terminal 280 in the red LD driver 210, the bias voltage V_{bias} is supplied to the emitters of the transistors TR1 and TR2 of the current mirror 290. The constant current I_{mod} is output from the collector of the output transistor TR2 as shown in Equation (2).

I_{mod}(Vm−Va)/R_{mpd} [2]

The output current I_{mod} can increase until it is equal to the output current I_{mpd} of the MPD 270. In this case, the generated light is not output.

On the other hand, when the constant current I_{mod} output from the output transistor TR2 of the current mirror 290 is added to the feedback current I_{mpd} output from the MPD 270 in the automatic power controller 320, the voltage drop is caused by the resistor circuit 300. The comparator 310 compares the dropped voltage with the preset reference voltage V_{REF}. As the amount of electric current increases, an output voltage of the comparator 310 has a negative value. The negative value output from the comparator 310 decreases an amount of electric current flowing to the current source 330 and decreases the light intensity of the red LD 240. As the light intensity of the red LD 240 decreases, the operating current flowing to the red LD 240 decreases. When the voltage magnitude is adjusted at the input terminal 280 of the modulation signal, a pulse-shaped light output can be adjusted and a continuous waveform can be output.

Although the principles of the invention have been described with regard to a red LD, it would be recognized by those skilled in the art that similar processing and operation would be applicable to green and blue (or an other color) LD utilized.

At least three LD drivers corresponding to the drive structure 200 for a sequential RGB display are connected in parallel. When the red, green, or blue modulation signal is input to the input terminal 280 in each of the RGB LD drivers 210, 220, and 230, the bias voltage vbias is supplied to the current mirror 290. When the constant current I_{mod} output from the current mirror 290 is added to the feedback current output I_{mpd} from one MPD 270 in the LD drive 210, 220, or 230, the comparator 310 compares the voltage vb of the resistor 300 with the preset reference voltage V_{REF}.

According to a comparison result, the current source 300 adjusts an amount of electric current to be supplied to the LD 240, 250, or 260, such that a control operation is performed to maintain the light power of the red, green or blue LD 240, 250, or 260. Light is sequentially emitted from the RGB LDs 240, 250, and 260 in response to R, G, and B modulation signals input to the input terminals 280.

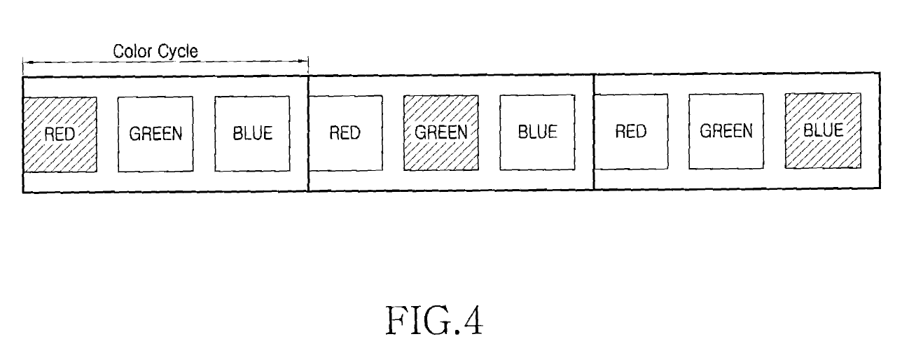

FIG. 4 illustrates a structure of fields within a frame of the drive structure for a sequential RGB display in accordance with an exemplary embodiment of the present invention.

As illustrated in FIG. 4, the drive structure 200 for a sequential ROB display in accordance with the exemplary embodiment of the present invention displays RGB signals in a color cycle according to a sequential switching operation. When 60 frames per second are displayed, a period for displaying one frame is divided into three RGB field periods. At least one pixel is displayed in each field period.

For example, when the number of pixels is (L×M), one field displays (L×M) pixels. Each light source driver sequentially displays one color of RED, GREEN or BLUE from the 1^{st} pixel to the (L×M)^{th} pixel.

A drive structure and method for a sequential RGB display can be implemented in accordance with the exemplary embodiments of the present invention.

Although the exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

In the present invention, one light receiving means receives partial light output from ROB light sources and performs conversion to a current signal, and each light source driver performs a control operation for maintaining the light intensity of each light source substantially constant by adjusting an amount of operating current applied thereto according to the magnitude of a feedback current provided from the light receiving means. Light is sequentially emitted and received from light sources in response to input RGB modulation signals. According to a simplified structure, a small-sized or cost-effective light source display device can be implemented.

What is claimed is:

1. A drive structure for a sequential Red-Green-Blue (RGB) display in a light source display device, comprising:
at least one light source for outputting light;
a light receiving means for receiving part of the light output from the at least one light source and performing conversion to a feedback current signal; and
at least one light source driver for performing a control operation for maintaining a light intensity of the at least one light source substantially constant by adjusting an operating current in response to the current provided from the light receiving means.

2. The drive structure of claim 1, wherein the at least one light source driver performs a control operation for sequentially controlling the output of light from the at least one light source in response to an external modulation signal.

3. The drive structure of claim 2, wherein the at least one light source driver comprises:
a current mirror for outputting a constant current in response to the external modulation signal;
a resistor circuit for dropping a voltage when the constant current of the current mirror is added to the feedback current output from the light receiving means;
a comparator for comparing a voltage of the resistor circuit with a preset reference voltage; and
an automatic power controller for controlling the operating current of the at least one light source according to a comparison result.

4. The drive structure of claim 3, wherein the automatic power controller comprises:
a current source for adjusting an amount of electric current to be supplied to the at least one light source in response to a signal output from the comparator.

5. The drive structure of claim 3, wherein the current mirror comprises:
an input terminal for receiving the external modulation signal through one end thereof;
a resistor for dropping a voltage according to the modulation signal from the input terminal; and
PNP input and output transistors,
wherein a common base of the transistors is connected to the resistor and a collector and a bias voltage is supplied to emitters of the transistors.

6. The drive structure of claim 1, wherein the at least one light source driver is selected from the group consisting of: red, green and blue laser diode drivers.

7. The drive structure of claim 1, wherein the at least one light source is selected from the group consisting of: red, green and blue laser diodes.

8. The drive structure of claim 7, wherein the laser diodes have a TO-CAN structure.

9. The drive structure of claim 1, wherein the light receiving means comprises a monitor photodiode.

10. A light emitting display device comprising:
a plurality of light emitting diodes;
a drive circuit in communication with an associated one of the plurality of light emitting diodes, said drive circuit providing a drive voltage to the associated light emitting diode;
a photo monitor in optical communication with said plurality of light emitting diodes, said photo monitor converting a received light into a feedback current and providing said feedback current to each of the drive circuits; and
timing means for controlling each of the drive circuits to provide a drive current to an associated light emitting diode for a known period of time.

11. The device of claim 10, wherein said drive current is determined dependent upon a modulated signal input to said drive circuit and said feedback current.

12. The device of claim 10, wherein said drive circuit comprises:
a current mirror for outputting a substantially constant current in response to the input modulation signal;
a resistor circuit for dropping a voltage when the substantially constant current of the current mirror is added to the feedback current;
a comparator for comparing a voltage of the resistor circuit with a preset reference voltage; and
an automatic power controller for controlling the operating current of the at least one light source according to a comparison result.

13. The device of claim 12, wherein the automatic power controller comprises:
a current source for adjusting an amount of electric current to be supplied to the corresponding light emitting diodes in response to a signal output from the comparator.

14. The device of claim 12, wherein the current mirror comprises:
an input terminal for receiving the input modulation signal through one end thereof;
a resistor for dropping a voltage according to the modulation signal from the input terminal; and
PNP input and output transistors,
wherein a common base of the transistors is connected to the resistor and a collector and a bias voltage is supplied to emitters of the transistors.

15. The device of claim 11, wherein the preset voltage is determined based on the wavelength emitted by the associated light emitting diode.

16. The device of claim 11, wherein the resistor circuit is dependent upon the color of light emitted by the associated light emitting diode.

17. The device of claim 10, wherein the timing means provides for sequential activation of each of drive circuits.

18. The device of claim 10, wherein the photo monitor is reversed biased independent of the drive circuits.
